(19) United States
(12) Patent Application Publication
(10) Pub. No.: US 2025/0167413 A1
(43) Pub. Date: May 22, 2025

(54) FLEXIBLE TWISTABLE WAVEGUIDE DEVICE

(71) Applicant: MacDonald, Dettwiler and Associates Corporation, Sainte-Anne-de-Bellevue (CA)

(72) Inventors: Stephane Lamoureux, Mirabel (CA); Alpha Dixon Steven Ross, Cornwall (CA); Gérard Sénéchal, Ste-Anne-de-Bellevue (CA)

(21) Appl. No.: 18/943,404

(22) Filed: Nov. 11, 2024

Related U.S. Application Data
(60) Provisional application No. 63/601,172, filed on Nov. 20, 2023.

(51) Int. Cl. H01P 1/02; H01P 5/02; H01P 11/00

(52) U.S. Cl. CPC H01P 1/025; H01P 5/024; H01P 11/002

(57) ABSTRACT

A flexible, twistable waveguide device is provided comprising a first flange for connecting the waveguide device to a first RF component and a second flange for connecting the waveguide to a second RF component, a waveguide body formed as a single piece, wherein the waveguide body transmits the RF waves through an interior cavity of the waveguide body, and wherein the waveguide body comprises a first linear section, a curved section, and a second linear section, the first linear section extending from the first flange to a first end of the curved section and the second linear section extending from the second flange to a second end of the curved section, wherein the waveguide body is elastically deformable, in up to six degrees of freedom, from an undeformed configuration to a deformed configuration, the deformed configuration being deformed in at least one of the six degrees of freedom.

### TECHNICAL FIELD

The following relates generally to radiofrequency (“RF”) waveguides, and more particularly to an RF waveguide device that is flexible and twistable.

### INTRODUCTION

Radiofrequency waveguides transmit radio waves (e.g., microwaves) along a hollow pipe or tube. These waveguides can be used to connect transmitters and receivers to antennae, in equipment used for various purposes including satellite communications. Current waveguides may have limited flexibility/twistability, and often have fabrication issues, long-lead times, high costs, and/or bad final fit to the components which are being connected. Current waveguides which are flexible, twistable or extendable include multiple pieces with sliding interfaces which are not conducive to radiofrequency transmission, and may cause power-handling issues, insertion loss, or passive intermodulation (PIM).

Accordingly, there is a need for an improved waveguide device that overcomes at least some of the disadvantages of existing systems and methods.

### SUMMARY

Provided herein may be a flexible twistable radiofrequency (“RF”) waveguide device for communicating RF waves between first and second RF system components, the waveguide device comprising a first flange for connecting the waveguide device to the first RF system component and a second flange for connecting the waveguide to the second RF system component, a waveguide body formed as a single piece, the waveguide body for transmitting the RF waves through an interior cavity traversing a length of the waveguide body, the waveguide body comprising a first linear section, a curved section, and a second linear section, the first linear section extending from the first flange to a first end of the curved section and the second linear section extending from the second flange to a second end of the curved section, wherein the waveguide body may be elastically deformable, in up to six degrees of freedom, from an undeformed configuration to a deformed configuration, the deformed configuration being deformed in at least one of the six degrees of freedom.

The waveguide body may be composed of an additively manufacturable material.

The first flange and the second flange may be formed together with the waveguide body as a single piece.

The waveguide body, the first flange, and the second flange may be composed of an additively manufacturable material.

The waveguide body may comprise a base material.

A surface finish may be applied to the base material.

The surface finish may be a plating material. The plating material may have a loss tangent greater than the loss tangent of the base material and superior to 100.

The surface finish may be a high conductivity coating/paint. The coating/paint may have a loss tangent greater than the based material and superior to 100.

In an embodiment, the base material may be a good conductor (i.e., loss tangent greater than 100). The base material may be a conductor at the operating frequency.

In an embodiment, the base material may be a bad conductor (i.e., loss tangent lower than 100) and the base material may be plated or coated/painted with a good conductor plating material (i.e., loss tangent greater than 100).

The base material may be chosen from a group consisting of: aluminum, copper, and brass.

The plating material may be chosen from a group consisting of silver, gold, and copper.

The base material may be a polymer.

A method of manufacturing a waveguide device comprising a first flange, a second flange, and a waveguide body including a first linear section, a curved section, and a second linear section, may comprise: additively manufacturing the waveguide device as a single piece wherein the first linear section extends from the first flange to a first end of the curved section and the second linear section extends from the second flange to a second end of the curved section, wherein the waveguide device comprises a base material with a loss tangent greater than 100.

The waveguide device may comprise a base material with a loss tangent greater than 100.

The method may further comprise applying a surface finish to the waveguide body, the surface finish composed of a material having a loss tangent greater than 100.

Applying the surface finish may comprise plating the waveguide body with a metal having a loss tangent greater than 100.

Applying the surface finish may comprise coating or painting the waveguide body with a high conductivity paint having a loss tangent greater than 100.

A process of manufacturing a waveguide device comprising a first flange, a second flange, and a waveguide body including a first linear section having a first end and a second end, a curved section having a first end and a second end, and a second linear section having a first end and a second end, may comprise: additively manufacturing the waveguide body as a single piece wherein the second end of the first linear section may be integral with the first end of the curved section and the first end of the second linear section may be integral with the second end of the curved section, wherein the waveguide body may comprise a base material having a loss tangent greater than 100, attaching the first flange to first end of the first linear section, and attaching the second flange to the second end of the second linear section.

The process may further comprise plating the waveguide device with a material having a loss tangent greater than 100.

The process may further comprise coating or painting the waveguide device with a material having a loss tangent greater than 100.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a front perspective of a flexible, twistable waveguide in an undeformed configuration, according to an embodiment;

FIG. 1B is a cross-sectional perspective view of the flexible, twistable waveguide of FIG. 1A, according to an embodiment;

FIG. 1C is a cross-sectional front view of the flexible, twistable waveguide of FIG. 1A, according to an embodiment;

FIGS. 2A-2C are side, rear perspective, and rear views, respectively, of the flexible twistable waveguide of FIGS. 1A-1C in an axially stretched configuration, showing deviation from the undeformed configuration;

FIGS. 3A-3C are side, rear perspective, and rear views, respectively, of the flexible twistable waveguide of FIGS. 1A-1C in an axially compressed configuration, showing deviation from the undeformed configuration;

FIGS. 4A-4D are side, rear perspective, rear, and top views, respectively of the flexible twistable waveguide of FIGS. 1A-1C in a configuration under torsional stress around the Z-axis, showing deviation from the undeformed configuration;

FIGS. 5A-5C are side, rear perspective, and rear view, respectively, of the flexible twistable waveguide of FIGS. 1A-1C in a configuration under torsional stress around the Z-axis, showing deviation from the undeformed configuration;

FIGS. 6A-6C are side, rear perspective, and rear views, respectively, of the flexible twistable waveguide of FIGS. 1A-1C bent around the Y-axis (easy direction), showing deviation from the undeformed configuration;

FIGS. 7A-7C are side, rear perspective, and rear views, respectively, of the flexible twistable waveguide of FIGS. 1A-1C bent around the X-axis (hard direction), showing deviation from the undeformed configuration;

FIGS. 8A-8C are side, rear perspective, and rear views, respectively, of the flexible twistable waveguide of FIGS. 1A-1C in a configuration under X enforced displacement combined with rotation around the Y-axis, showing deviation from the undeformed configuration;

FIGS. 9A-9C are side, rear perspective, and rear views of the flexible twistable waveguide of FIGS. 1A-1C in a configuration under X enforced displacement combined with rotation around the Y-axis, showing deviation from the undeformed configuration;

FIGS. 10A-10D are side, rear perspective, rear, and top views of the flexible twistable waveguide of FIGS. 1A-1C in a configuration with enforced displacement in Y direction, showing deviation from the undeformed configuration;

FIGS. 11A-11C are side, rear perspective, and rear views of the flexible twistable waveguide of FIGS. 1A-1C in a configuration with enforced displacement in the opposite Y direction, showing deviation from the undeformed configuration;

FIGS. 12A-12D are side, rear perspective, rear, and top views, respectively, of the flexible twistable waveguide of FIGS. 1A-1C in a configuration with enforced displacement in the X direction, showing deviation from the undeformed configuration;

FIGS. 13A-13C are side, rear perspective, and rear views of the flexible twistable waveguide of FIGS. 1A-1C in a configuration with enforced displacement in the opposite X direction, showing deviation from the undeformed configuration;

FIG. 14 is a block diagram of a flexible, twistable waveguide, such as the waveguide of FIGS. 1A-13C, connecting a first system to a second system, according to an embodiment;

FIG. 15 is a block diagram of a flexible twistable waveguide, such as the waveguide of FIGS. 1A-13C, connecting a waveguide of a first system to a waveguide of a second system, according to an embodiment;

FIG. 16A is a schematic diagram of an antenna system including a plurality of flexible, twistable waveguides of FIGS. 1A-13C, according to an embodiment;

FIG. 16B is a close up view of a first portion of the antenna system of FIG. 16A;

FIG. 16C is a close up view of a second portion of the antenna system of FIG. 16A;

FIGS. 17A-17D are front, side, top, and rear perspective views, respectively, of a flexible, twistable waveguide, according to an embodiment; and

FIGS. 18A and 18B are photographs of a flexible, twistable waveguide, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The following relates generally to radiofrequency (RF) waveguides, and more particularly to an RF waveguide device that is flexible and twistable.

Provided herein are flexible, twistable waveguides. A transmission portion of the compliant waveguide is manufactured as a single piece which is flexible and twistable. An embodiment of the flexible, twistable waveguide includes two linear sections of waveguide connected by a curved section in the middle. The curved section may be a single “donut” shaped curve. The curved section may be a spiral. The spiral may have multiple turns. The structure of the waveguide allows decoupling of the waveguide interface in all degrees of freedom. The flexible and twistable nature of the waveguide enables a compliant final fit between the waveguide and the components to which the waveguide is connecting, which enables proper mating of the interfaces, improved radiofrequency transmission and prevents power-handling, insertion loss, and PIM issues.

The waveguide is composed of a generic base material. Generic base material means any material suitable for the basic waveguide geometry may be used. Examples of generic base materials include, without limitation, aluminum, invar (plated), titanium (plated), beryllium-copper, brass, copper, polymer (plated or coated/painted), etc.

The walls of the waveguide are sufficiently thin to enable flexibility of the waveguide. The thinness required may depend on the material of the waveguide and/or the overall size and configuration of the flexible, twistable waveguide.

The walls of the waveguide are sufficiently smooth to enable RF wave transmission.

The interior surface of the waveguide must comprise a high conductivity material. The generic base material may be a high conductivity material.

The waveguide may be manufactured by additive manufacturing or by other means which enable a single piece to be created, such as, for example, electroforming.

The waveguide may be composed of an additively manufacturable material. The waveguide may be composed of aluminum. The waveguide may be composed of copper. The waveguide may be composed of any printable high conductivity material, and/or printable material onto which one can apply a high conductivity surface finish. A high conductivity material or surface finish may be one with a loss tangent greater than 100. Loss tangent is a parameter which provides the relation between the conductivity, the permittivity, and the angular frequency.

While the waveguide is manufactured as a single piece, the waveguide may have a surface finish applied. For example, the waveguide may be composed of aluminum or a polymer which may be plated with a plating material or coated/painted with a high conductivity paint. The plating material may be silver. The plating material may be any other suitable plating material, for example, copper or gold. Plating the waveguide may further reduce insertion loss.

Manufacturing the flexible, twistable waveguide as a single piece may reduce the cost of manufacture. The flexible and twistable nature of the waveguide allows for the waveguide to fit properly in multiple different scenarios, as long as the waveguide is designed with sufficient length, flexibility, and twistability for the task. The flexible and twistable nature of the waveguide allows for some movement, relative to nominal, of the systems to which the waveguide is connecting.

The single piece of the waveguide may include flanges at each end for connecting the waveguide to payloads at either end of the waveguide. The single piece may include only the part of the waveguide through which waves are transmitted, with flanges (or other connecting pieces) being attached to the waveguide as separate pieces. The flanges may be attached to the single piece waveguide by soldering, or brazing, or other means.

The flange connection and the flexible, twistable nature of the waveguide allow for disconnecting and reconnecting the waveguide as well as re-using the waveguide in other scenarios and configurations.

The flexible twistable waveguide of the present disclosure may be used at various locations. The flexible twistable may be used as a final fit waveguide to account for tolerance stack-up and/or consequence of alignment needs. The flexible twistable waveguide may be used as a structural decoupling feature at the waveguide interface (i.e., to structurally decouple two distinct systems). In an example, the flexible twistable waveguide may be used in between a feed system and a tower system. In another example, the flexible twistable waveguide may be used in between a tower system and a spacecraft/transponder system. In another example, the flexible twistable waveguide may be used in between a spacecraft-panel/transponder system and another spacecraft- panel/transponder system.

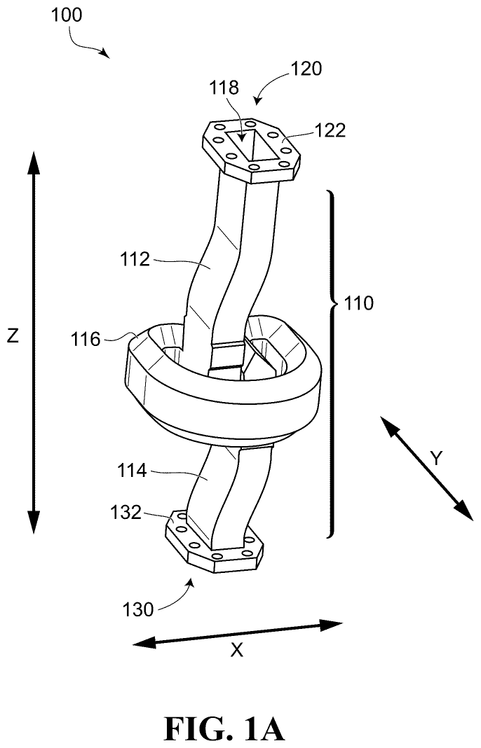

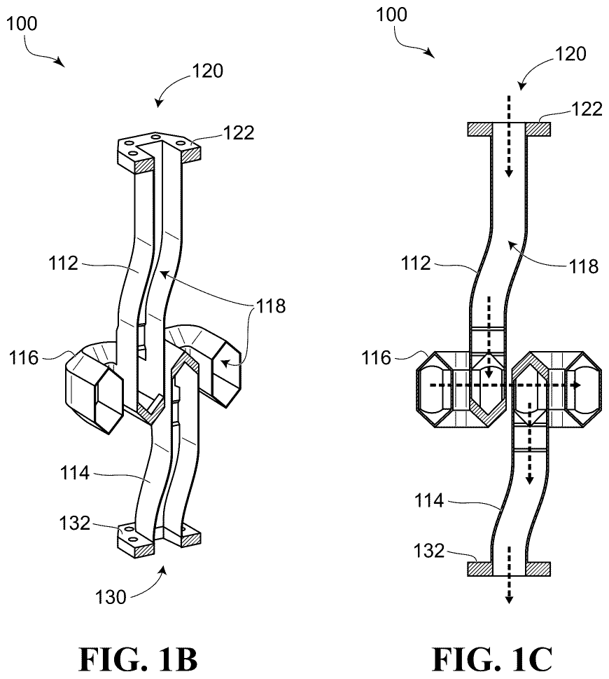

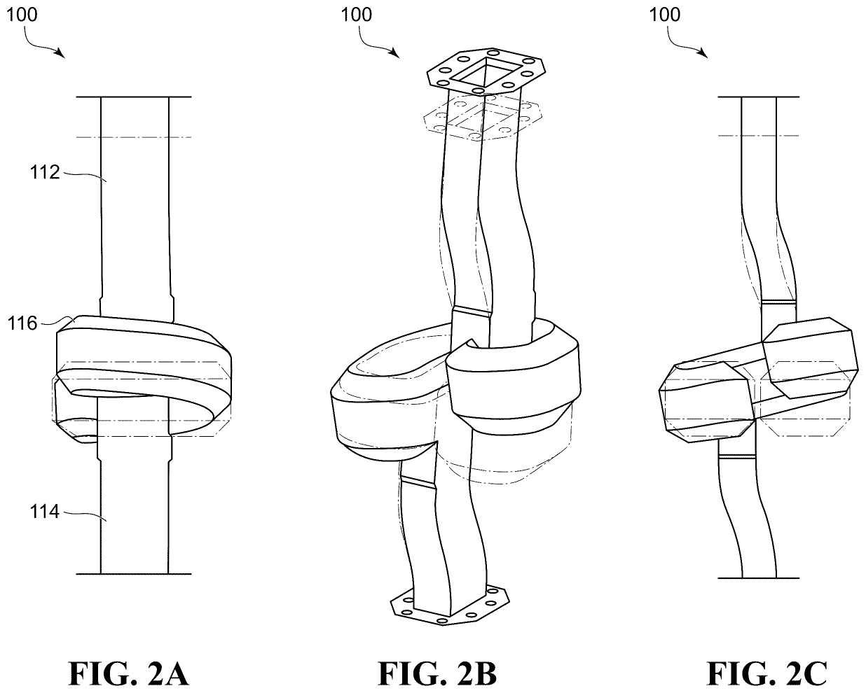

Referring now to FIGS. 1A to 1C, shown therein is a flexible, twistable RF waveguide device 100 in an undeformed configuration, according to an embodiment. The undeformed configuration moves to an elastically deformed configuration when an external force is applied to the waveguide 100, as described herein. Upon removal of that force, the waveguide is configured to return to the undeformed configuration.

Waveguide 100 includes a waveguide body 110, a first end 120, and a second end 130. The waveguide body 110 includes a cavity 118 that runs the length of the waveguide body 110. In an embodiment, the interior walls of the waveguide body 110 that define the cavity 118 waveguide body 110 are flat/smooth (i.e., not corrugated). This may improve insertion loss of the waveguide 100 over corrugated waveguides. Certain shape properties of the waveguide body 110, further described below, gives the waveguide body 110 inherent flexibility, twistability and printability. The waveguide body 110 of waveguide 100 is rectangular (i.e., has a rectangular cross section along its length). In other embodiments, the waveguide body 110 may have a different cross section shape.

The waveguide body 110 is a single piece hollow section of the waveguide 100 through which the radiofrequency waves are transmitted or communicated. The waveguide body 110 includes a first linear section 112 and a second linear section 114 connected by a curved section 116. The curved section of waveguide 100 has a partial “donut” shape. The first linear section 112, curved section 116, and second linear section 114 are a single, hollow piece.

In some embodiments, the linear sections 112 and 114 may be bent as in FIGS. 1A-13C. In other embodiments the linear section 112 and 114 may be straight. The linear sections are described as “linear” as they are roughly positioned along an axis corresponding to the overall direction of the transmission of the RF waves. The shape of the linear section may be custom to ensure proper configuration between the ports to be interconnected.

In other embodiments, the curved section 116 may be a spiral. The curved section or spiral may have a fraction of a turn, a single turn or multiple turns. The curved section 116 may also be referred to as elastic section 116, non-plastic deformation section 116, spring section 116, spiral section 116, or turn section 116. The selected configuration of the flexible, twistable waveguide may depend on the positional relationship of the two interfaces that are being interconnected, how off from nominal they might be in practice, the first natural frequency, and the structural strength requirement of the flexible, twistable waveguide itself.

The waveguide body 110 is composed of at least a base material. The waveguide body 110 may be manufactured as a single piece by additive manufacturing (e.g., 3D printing), wherein the base material is a printable material.

The waveguide body 110 includes a high conductivity material surface in the cavity 118 of the waveguide body 110 for transmission of RF waves.

In an embodiment, the base material is high conductivity, providing a loss tangent greater than 100.

The waveguide body 110 base material may be (preferably) aluminum. In other embodiments, the waveguide body 110 base material may be copper or another flexible, twistable material. In some applications, such as space-based applications subject to mass constraints, aluminum may be preferred over heavier materials such as copper.

In some embodiments, a material with higher conductivity than the base material may be required and the waveguide body 110 may have a surface finish applied. The surface finish has a conductivity higher than that of the base material. The surface finish may be a plating. The plating material may be silver, gold, or copper. The surface finish may be a high conductivity coating or paint.

The waveguide body 110 base material may be composed of a polymer. The polymer may have a surface finish applied, such as a plating or coating/paint, that has a high enough conductivity for transmission of RF waves. A waveguide with a low conductivity base material and a high conductivity plating or coating/paint may be lighter than a waveguide with a high conductivity base material, however, the usefulness of a polymer waveguide body 110 is limited due to risk of cracking or peeling and temperature restrictions.

The waveguide body 110 may be manufactured as a single piece by electroforming.

The first end 120 includes a first flange 122. The second end 130 includes a second flange 132. The first flange 122 and the second flange 132 are used to connect the waveguide body 110 to a first system and a second system, respectively. The first system transmits or communicates RF waves which pass into the waveguide body 110 and the second system receives RF waves which pass out of the waveguide body 110.

The first flange 122 and the second flange 132 may be manufactured together with the waveguide body 110 as a single piece. The single piece may be additively manufactured. The single piece may comprise aluminum. The single piece may be electroformed. The single piece may comprise a polymer. The single piece may have an applied surface finish, such as a plating or coating/paint. The plating material may be silver, copper, or gold. The coating material may be a high conductivity paint.

FIG. 1A shows a perspective view of the waveguide with arrows X, Y, and Z showing axes about which the waveguide is elastically displaceable or deformable. Arrow Z represents an axial direction roughly aligned with the linear sections 112 and 114. Arrow X and arrow Y represent perpendicular axes along the plane of the waveguide flange.

Displacement about the X, Y, and Z axes can include positive or negative displacement. The displacement may be any combination of movement through all degrees of freedom. The displacement may include any one or more of the following: (i) deflection/enforced-displacement along +Z, −Z (tension, compression) +X, −X, +Y, −Y directions; (ii) bending, either positive or negative, around the X or Y axes; (iii) twisting/torsion/rotation, either positive or negative (i.e., clockwise or counter-clockwise), around the Z axis; and (iv) a combination of some or all of the above (e.g., deflection, bending, twisting).

FIGS. 1B and 1C show cross-sectional views of the waveguide 100 with a view of an interior or cavity of the waveguide body 110 wherein the RF waves are transmitted. The dashed arrows of FIG. 1C show the direction of the RF waves through the waveguide body 110 with the RF waves entering linear section 112 at first end 120, then passing through curved section 116, and then through and out of linear section 114 at second end 130. In another example, the RF waves may travel in the opposite direction.

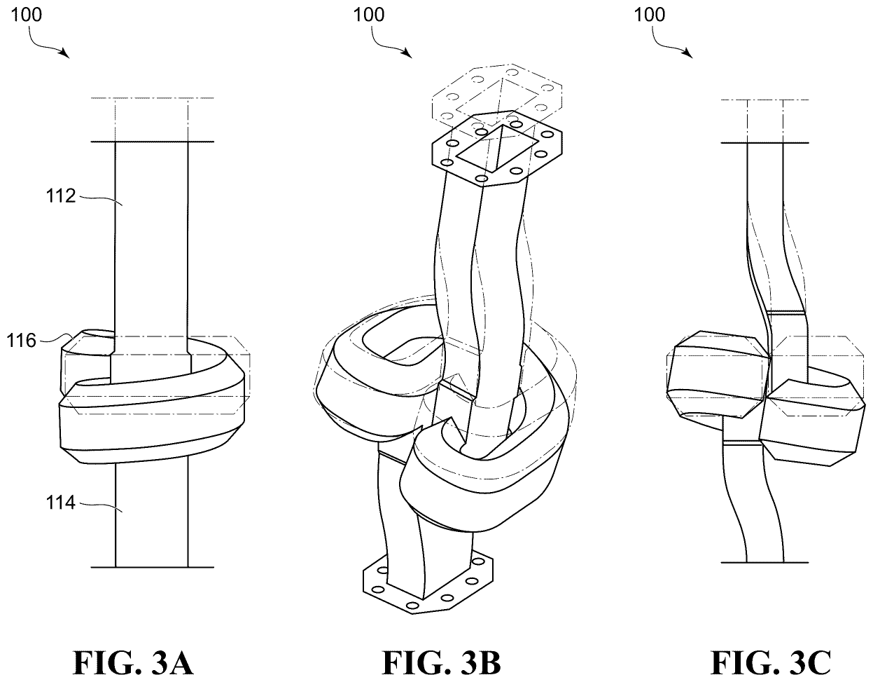

FIGS. 2A-13C show the waveguide 100 of FIGS. 1A-1C in various elastically deformed configurations to illustrate the flexible and twistable nature of the waveguide 100. The undeformed configuration of waveguide 100 is represented in FIG. 2A-13C by lines which do not include any shading to represent the shape within the lines and to illustrate the deformation from the undeformed configuration.

In FIGS. 2A-13C, components which are the same as components in FIGS. 1A-1C are labelled with the same last two digits preceded by the number of the Figure. For example, in FIG. 2A the first linear section is first linear section 212. Not all components of FIGS. 2A-13C are labelled for simplicity. Only those components which have moved are labelled. It is to be understood that, regardless of labelling, all of the components of FIGS. 1A-1C are present in the waveguides of FIGS. 2A-13C.

FIGS. 2A-2C show the waveguide 100 in an axially stretched configuration (axially tension). Only FIG. 2A is labelled.

The first linear section 112 of waveguide 100 as well as the side of the curved section 116 closest to first linear section 112 have been pulled up from the rest of waveguide 100 away from second end 130 compared to an undeformed configuration.

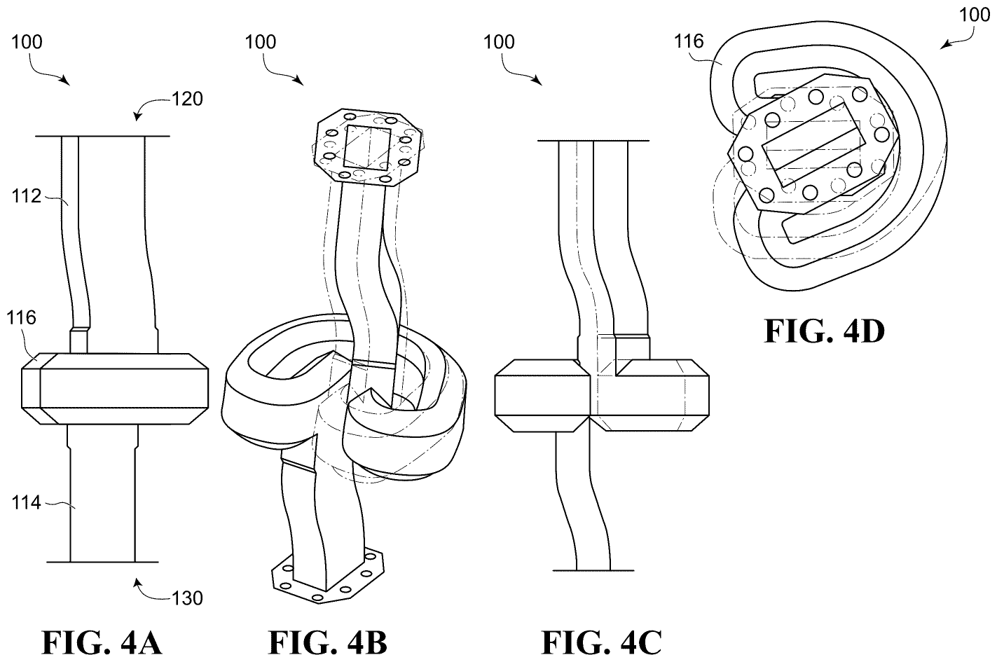

FIGS. 3A-3C show the waveguide 100 in an axially compressed configuration (axial compression). Only FIG. 3A is labelled.

The first linear section 112 and the side of the curved section 116 which is closer to the first linear section 112 have been pushed down towards second end 130 compared to an undeformed configuration.

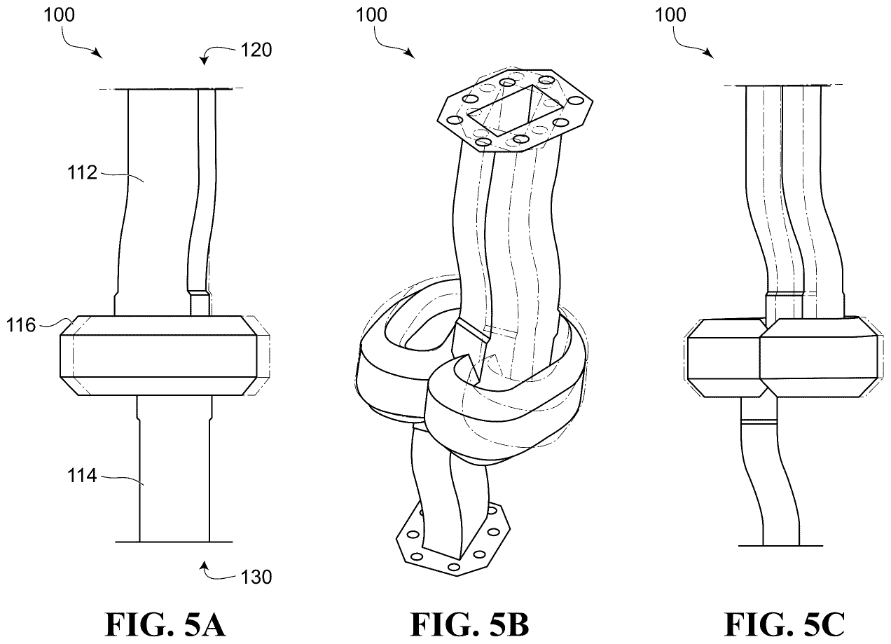

FIGS. 4A-4D show the waveguide 100 in a configuration under torsional stress around the Z-axis (torsion/rotation about Z-axis). Only FIGS. 4A and 4D are labelled.

The first linear section 112 and the side of the curved section 116 closest to the first linear section 112 have been twisted with respect to the second linear section 114 and the side of the curved section 116 which is closest to the second linear section 114.

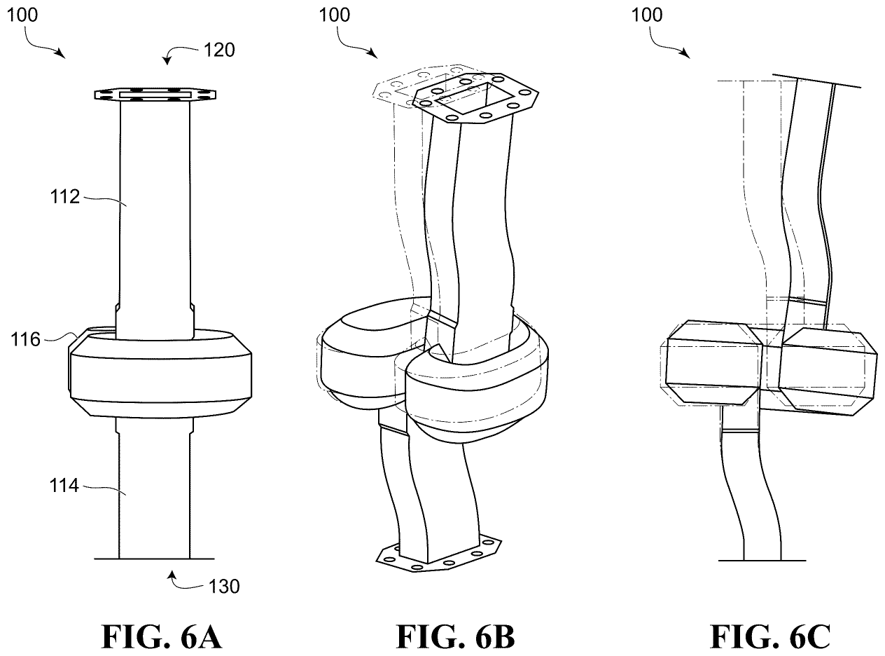

FIGS. 5A-5C show the waveguide 100 in a configuration under torsional stress around the Z-axis. Only FIG. 5A is labelled.

The first linear section 112 has moved “inwards” toward second linear section 114 and the curved section 116 has curved inward such that the “donut” shape of the curved section 116 is a “tighter” donut shape.

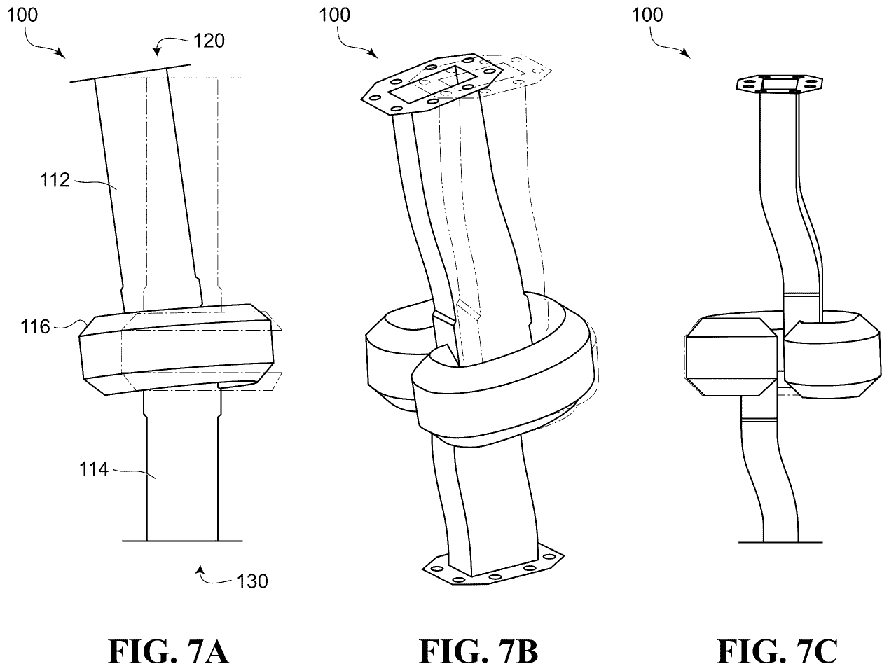

FIGS. 6A-6C show the waveguide 100 bent around the Y-axis (easy direction). Only FIG. 6A is labelled.

The first linear section 112 has bent around the Y-axis with the part of the curved section 116 closest to first linear section 112 moving down towards the second end 130 and the part of the curved section 116 closest to the second linear section 114 moving up towards the first end 120.

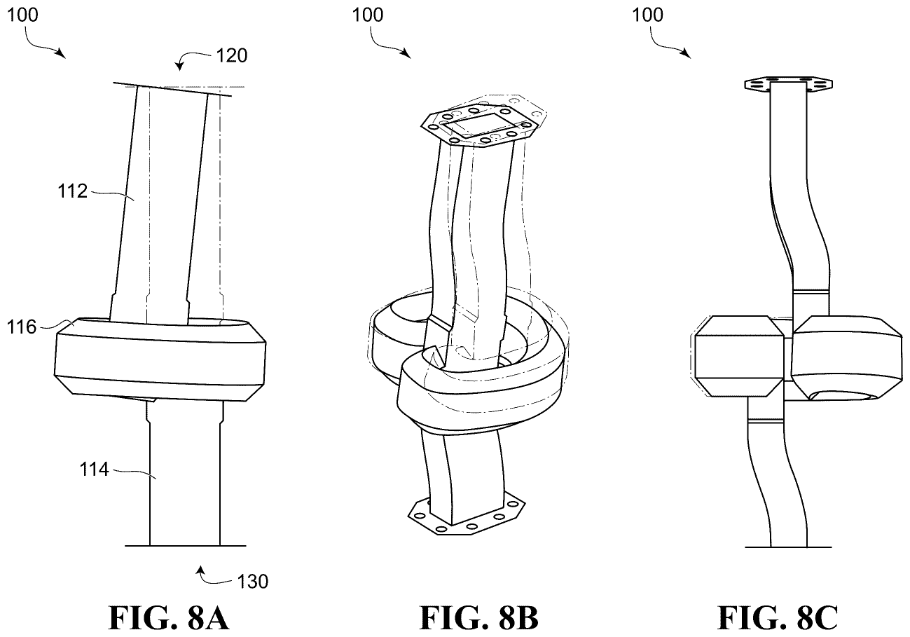

FIGS. 7A-7C show the waveguide 100 bent around the X-axis (hard direction). Only FIG. 7A is labelled.

The first linear section 112 has been displaced around the X-axis.

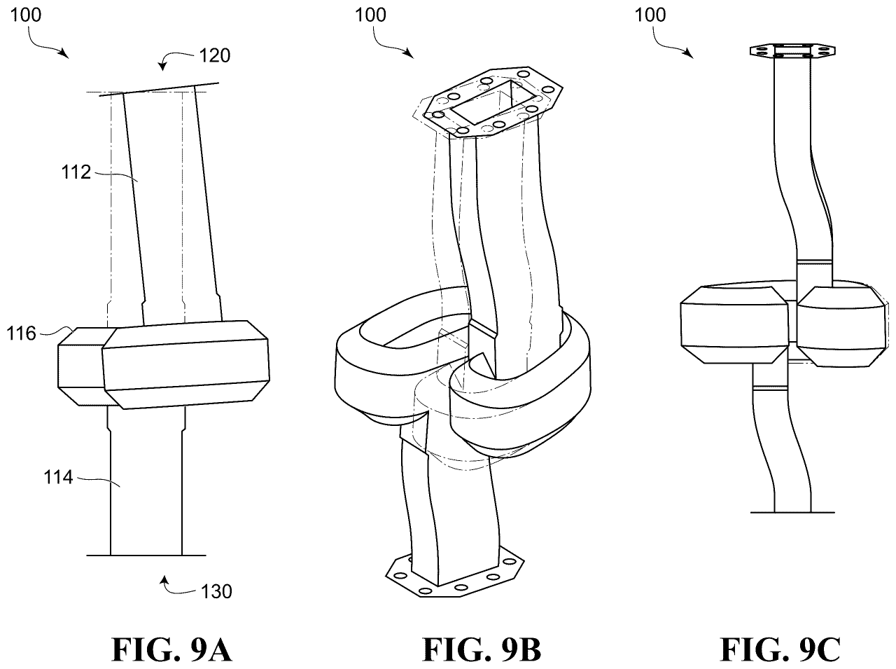

FIGS. 8A-8C show the waveguide 100 in a configuration under X displacement combined with rotation around Y-axis. Only FIG. 8A is labelled.

Both the first linear section 112 and the curved section 116 have been displaced in the X-axis and down from the undeformed position of the first end 120, and the rotation about the Y-axis moving section 116 partially back up.

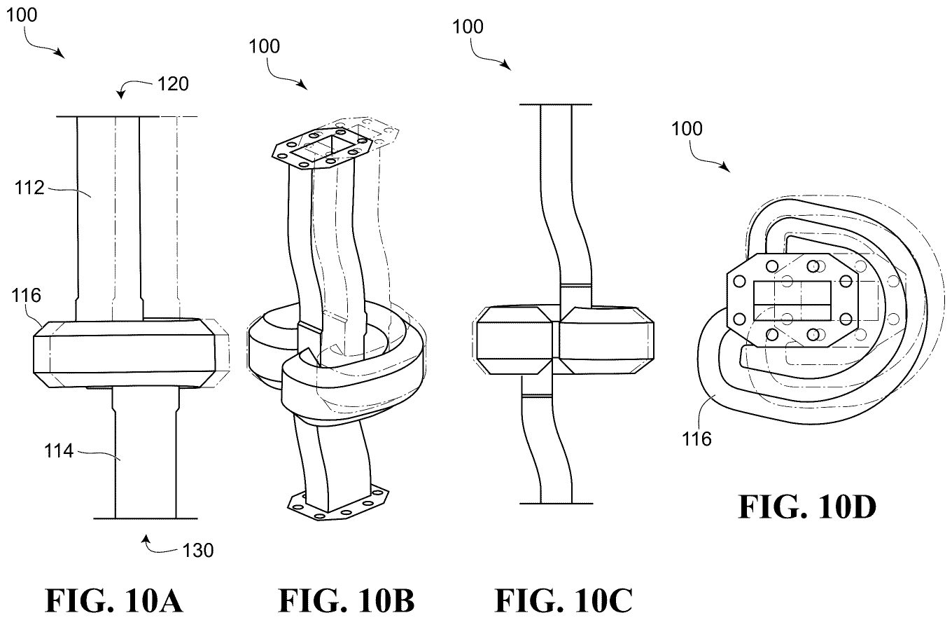

FIGS. 9A-9C show the waveguide 100 in a configuration under X displacement combined with rotation around X-axis. Only FIG. 9A is labelled.

The first linear section 112 and the curved section 116 have been displaced in the X-axis and have moved up from the undeformed position of the first end 120.

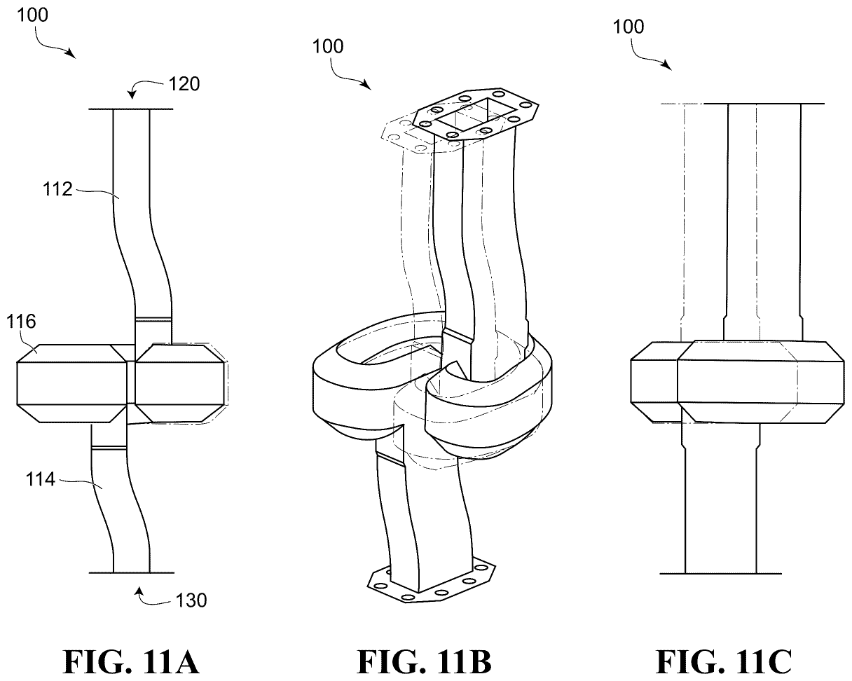

FIGS. 10A-10D show the waveguide 100 in a configuration with displacement in Y-axis. Only FIGS. 10A and 10D are labelled.

The first linear section 112 and the entire curved section 116 have been displaced along the Y-axis towards the second linear section 114.

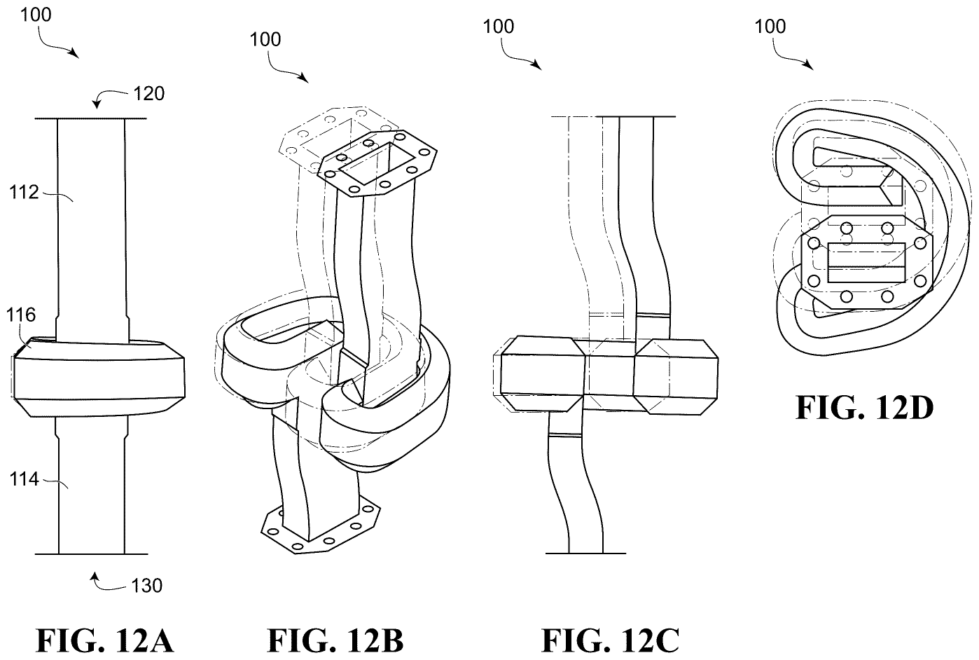

FIGS. 11A-11C show the waveguide 100 in a configuration with displacement in X direction. Only FIG. 11A is labelled.

The first linear section 112 and the curved section 116 have been displaced along the X-axis away from the second linear section 114.

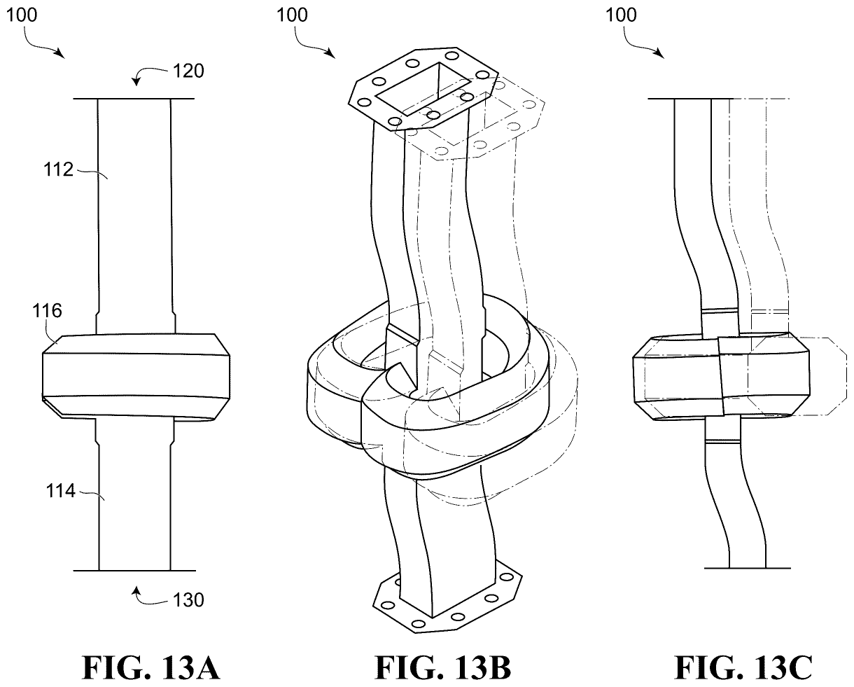

FIGS. 12A-12D show the waveguide 100 in a configuration with displacement in +X direction. Only FIGS. 12A and 12D are labelled.

The first linear section 112 and the part of the curved section 116 closest to the first linear section 112 are displaced along the X axis away from the second linear section 114 and the part of the curved section 116 closest to the second linear section 114.

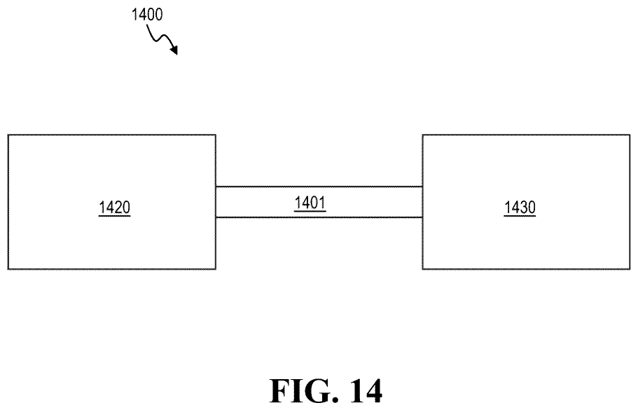

FIGS. 13A-13C show the waveguide 100 in a configuration with displacement in the-X direction. Only FIG. 13A is labelled.

In the opposite direction to FIGS. 12A-12D, the first linear section 112 and the part of the curved section 116 closest to the first linear section 112 are displaced along the X axis towards the second linear section 112.

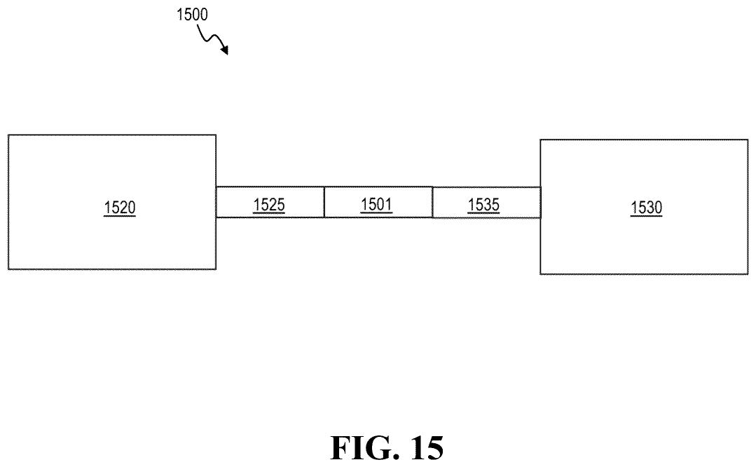

Referring now to FIG. 14, shown therein is RF communication system 1400 including a flexible, twistable waveguide 1401, such as the waveguide 100 of FIGS. 1A-13C, according to an embodiment. Generally, for operation of system 1400, first and second subsystems 1420, 1430 are to be in RF communication with one another. It may be desired to connect first and second subsystems 1420, 1430 via a final fit waveguide.

Generally, the first subsystem 1420 is configured to physically couple to a first end of the flexible twistable waveguide 1401 and the second subsystem 14300 is configured to physically couple to a second end (opposite the first end) of the flexible twistable waveguide 1401.

Waveguide 1401 may include a flange at each end for coupling to respective flanges on the first and second subsystems 1420, 1430.

First and second subsystems 1420, 1430 may be any systems which are to communicate RF signals therebetween. In an example, first subsystem 1420 may be a spacecraft and second subsystem 1430 may be an antenna mounted on the spacecraft 1420. In another embodiment, the first subsystem 1420 may be a transponder and the second subsystem 1430 may be an antenna. In another embodiment, first and second subsystems 1420, 1430 may be, for example, a first transponder panel of a spacecraft and a second transponder panel of the spacecraft. Accordingly, the waveguide 1401 may be used to directly connect two subsystems in an RF communication system.

The waveguide 1401 transmits RF waves from the first subsystem 1420 to the second subsystem 1430. The first subsystem 1420 transmits RF waves and the second subsystem 1430 receives the RF waves. Advantageously, the fit of the waveguide 1401 between the first subsystem 1420 and the second subsystem 1430 can be adjusted to be properly connected due to the flexible and twistable nature of the waveguide 1401.

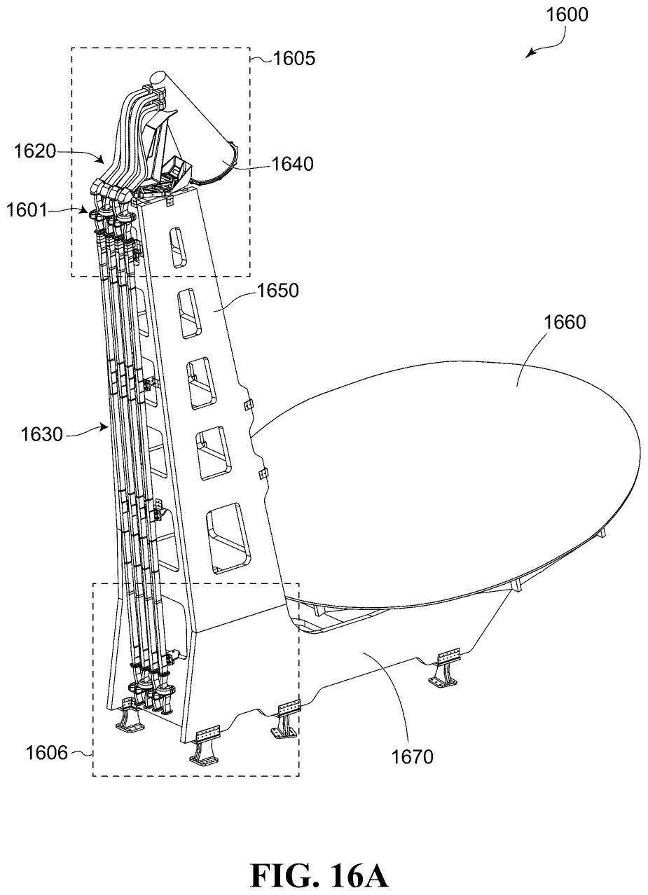

Referring now to FIG. 15, shown therein is an RF communication system 1500 including a flexible twistable waveguide 1501, such as the waveguide 100 of FIGS. 1A-13C, connecting a waveguide 1525 of a first subsystem 1520 to a waveguide 1535 of a second subsystem 1530, according to an embodiment.

The RF communication system 1500 also includes first subsystem 1520, first subsystem waveguide 1525, second subsystem 1530, and second subsystem waveguide 1535. The flexible twistable waveguide 1501 connects the first and second subsystem waveguides 1525, 1535 (and thus connects first and second subsystems 1520, 1530).

In system 1400 of FIG. 14, the first subsystem 1420 directly transmitted RF waves into the waveguide 1401 and the second subsystem 1430 directly received RF waves from the waveguide 1401.

In system 1500 of FIG. 15, the first subsystem 1520 transmits RF waves into the waveguide 1501 through the first subsystem waveguide 1525 and the RF waves are transmitted to a receiver of the second subsystem 1530 via the second subsystem waveguide 1535. Advantageously, the fit of the waveguide 1501 between the first subsystem waveguide 1525 and the second subsystem waveguide 1535 can be adjusted to be properly connected due to the flexible and twistable nature of the waveguide 1501.

Generally, the first subsystem waveguide 1525 is configured to physically couple to a first end of the flexible twistable waveguide 1501 and the second subsystem waveguide 1535 is configured to physically couple to a second end (opposite the first end) of the flexible twistable waveguide 1501. Waveguide 1501 may include a flange at each end for coupling to respective flanges on the first and second subsystem waveguides, 1525 and 1535.

First and second subsystems 1520, 1530 may be any systems which are to communicate RF signals therebetween. In an example, first subsystem 1520 may be a spacecraft and second subsystem 1530 may be an antenna mounted on the spacecraft 1520. In another embodiment, the first subsystem 1520 may be a transponder and the second subsystem 1530 may be an antenna. In another embodiment, first and second subsystems 1520, 1530 may be, for example, a first transponder panel of a spacecraft and a second transponder panel of a spacecraft.

In other embodiments the flexible, twistable waveguide may be connected to a subsystem waveguide only at one end and directly to another subsystem at the other end (e.g., without a subsystem waveguide).

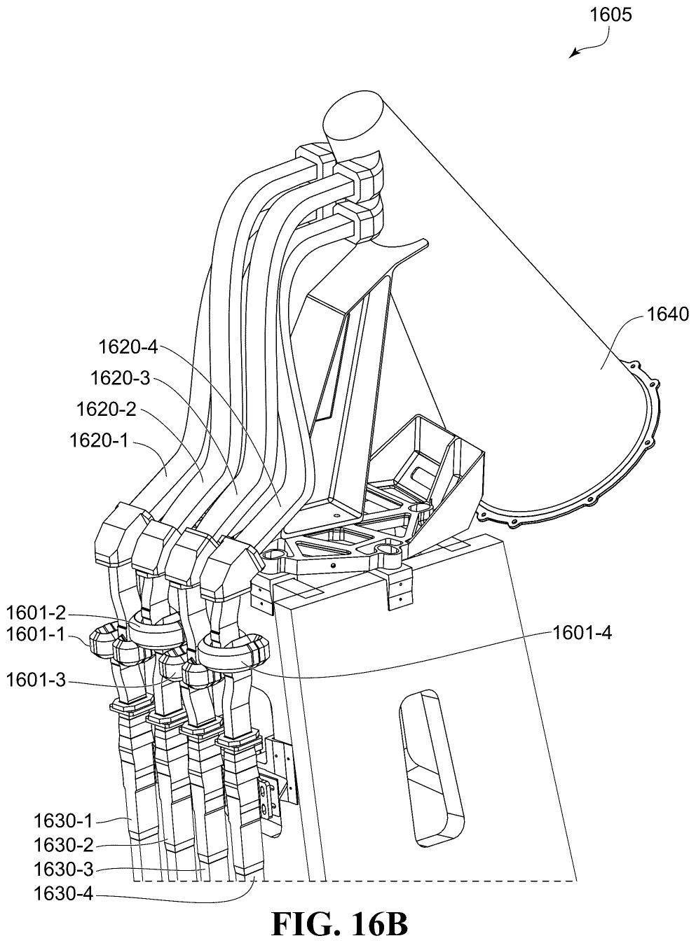

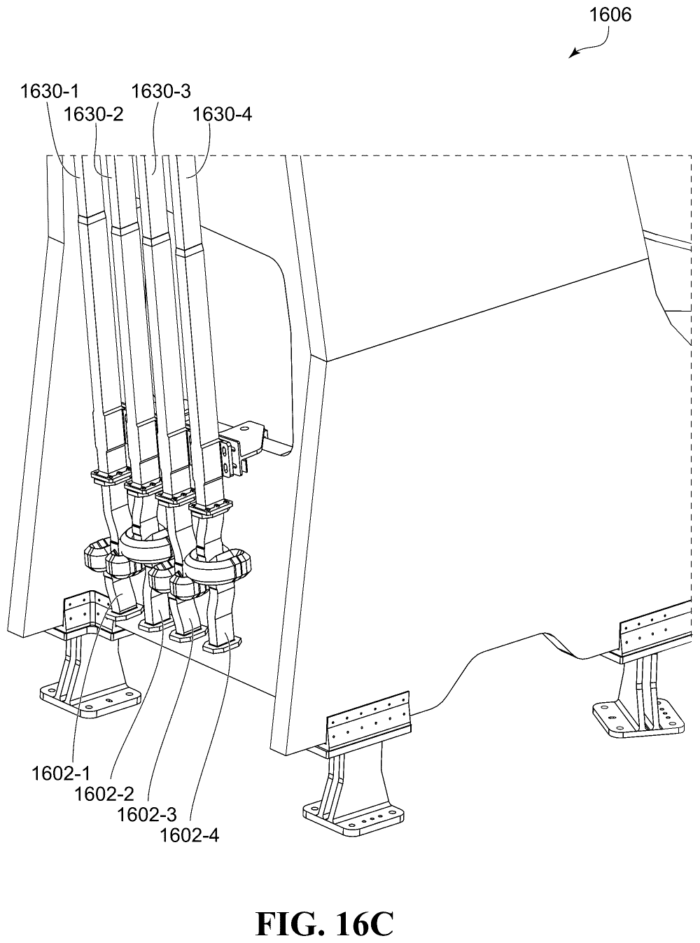

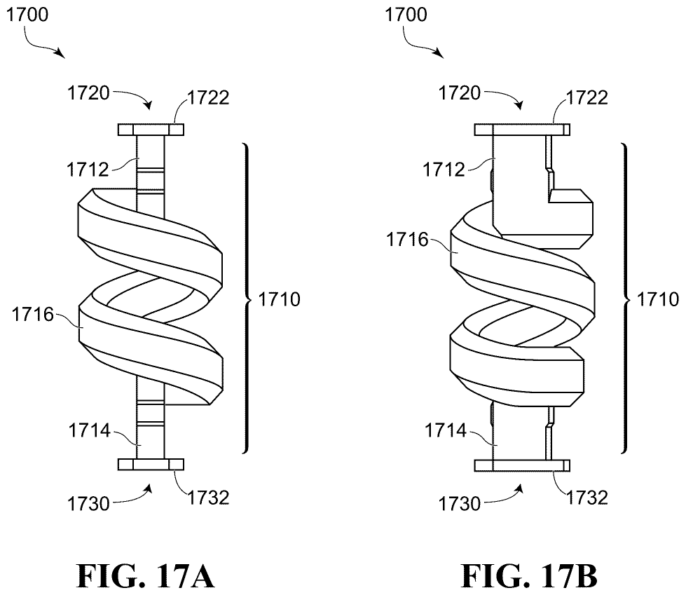

Referring now to FIGS. 16A-16B, shown therein is of an antenna system 1600, according to an embodiment. The antenna system 1600 includes a plurality of flexible, twistable waveguides 1601. Flexible, twistable waveguides 1601 are similar or identical to flexible, twistable waveguide 100 of FIGS. 1A-13C. In an embodiment, the antenna system 1600 is a Ku band antenna.

The antenna system 1600 includes a reflector 1660 for reflecting an RF signal and a horn radiating element 1640 (horn antenna 1640) for transmitting or receiving the RF signal. The antenna system 1600 further includes a support structure including first (vertical) support structure 1650 and second (horizontal) support structure 1670. Horn radiating element 1640 is mounted on vertical support structure 1650. Reflector 1660 is mounted on horizontal support structure 1670.

The antenna system 1600 further includes an RF signal feed chain including horn waveguides 1620, flexible twistable waveguides 1601 and 1602, and antenna tower waveguides 1630. The flexible, twistable waveguides 1601 would, in operation, connect the antenna system 1600 to satellite spacecraft/transponder waveguides (not shown).

Where the antenna system 1600 is a receive system, the reflector 1660 reflects RF waves to the horn radiating element 1640, which receives the reflected RF waves. The horn 1640 directs the RF waves into the waveguide feed chain. The RF waves are then transmitted through the horn waveguides 1620, through the flexible twistable waveguides 1601 to the antenna tower waveguides 1630. The antenna tower waveguides 1630 may connect to, for example, a spacecraft waveguide or a spacecraft transponder via the flexible, twistable waveguides 1602.

In FIG. 16B, shown therein is a close up of section 1605 of antenna system 1600 illustrating the waveguide feed chain in further detail.

Horn waveguides 1620 include four waveguides 1620-1, 1620-2, 1620-3, 1620-4. Flexible twistable waveguides 1601 include four waveguides 1601-1, 1601-2, 1601-3, 1601-4. Antenna tower waveguides 1630 include four waveguides 1630-1, 1630-2, 1630-3, 1630-4. The flexible twistable waveguides 1601 connect the horn waveguides 1620 to the antenna tower waveguides 1630.

In FIGS. 16A, 16B, and 16C, the antenna system 1600 is described as a receiving system. In other embodiments, the antenna system 1600 may be a transmitting system. Where the antenna system 1600 is a transmitting system, the directional flow of the RF waves through the waveguides would be reversed.

The RF waves received at the antenna horn 1640 pass into satellite waveguides 1620 which are connected to antenna tower waveguides 1630 by flexible, twistable waveguides 1601. In FIGS. 16A and 16B there are four each of waveguides 1601, antenna feed waveguides 1620, and antenna tower waveguides 1630. The respective waveguides 1620 and 1630 may be connected to the waveguides 1601 at one end by flanges.

Horn waveguide 1620-1 is connected to flexible, twistable waveguide 1601-1, which is in turn connected to antenna tower waveguide 1630-1.

Horn waveguide 1620-2 is connected to flexible, twistable waveguide 1601-2, which is in turn connected to antenna tower waveguide 1630-2.

Horn waveguide 1620-3 is connected to flexible, twistable waveguide 1601-3, which is in turn connected to antenna tower waveguide 1630-3.

Horn waveguide 1620-4 is connected to flexible, twistable waveguide 1601-4, which is in turn connected to antenna tower waveguide 1630-4.

The compliant nature of the flexible twistable waveguides 1601 provide an effective final fit for the respective antenna feed waveguides and antenna tower waveguides.

In FIG. 16C, shown therein is a close up of section 1606 of antenna system 1600 illustrating the antenna waveguides, in particular flexible, twistable waveguides 1602-1, 1602-2, 1602-3, 1602-4.

Antenna tower waveguides 1630 include four waveguides 1630-1, 1630-2, 1630-3, 1630-4.

Antenna tower waveguide 1630-1 is connected to flexible, twistable waveguide 1602-1, which in turn in operation may be connected to a spacecraft waveguide or other component of a satellite payload.

Antenna tower waveguide 1630-2 is connected to flexible, twistable waveguide 1602-2, which in turn in operation may be connected to a spacecraft waveguide or other component of a satellite payload.

Antenna tower waveguide 1630-3 is connected to flexible, twistable waveguide 1602-3, which in turn in operation may be connected to a spacecraft waveguide or other component of a satellite payload.

Antenna tower waveguide 1630-4 is connected to flexible, twistable waveguide 1602-4, which in turn in operation may be connected to a spacecraft waveguide or other component of a satellite payload.

When connected, the flexible twistable waveguides 1602 provide an effective final fit for the respective antenna tower waveguides and satellite waveguides (not shown).

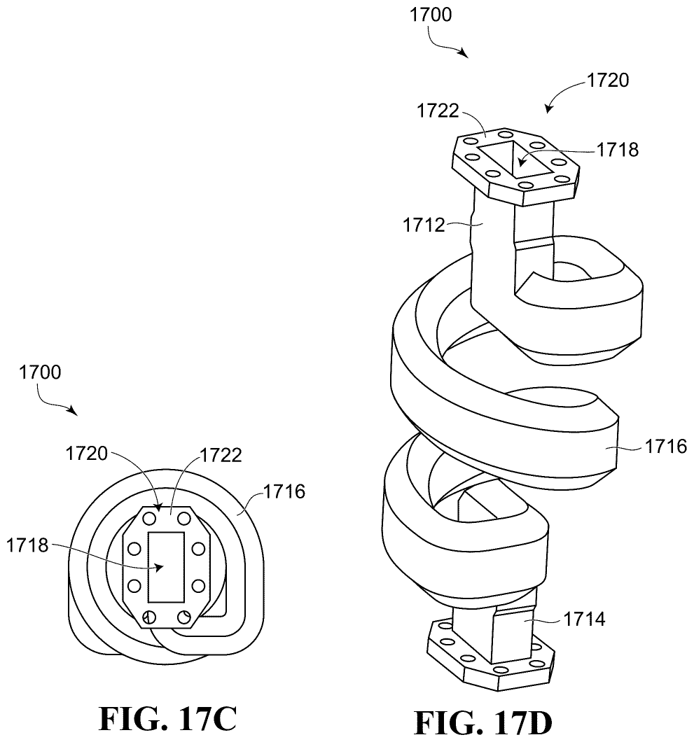

Referring now to FIGS. 17A-17D, shown therein is a flexible twistable waveguide 1700, according to an embodiment. In another embodiment of the system 1600 of FIG. 16A, the waveguides 1601 may be replaced by four instances of waveguide 1700.

Waveguide 1700 is similar to waveguide 100. Similar or counterpart components are given similar numbers (e.g., 112, 1712). Features of waveguide 1700 that are present in waveguide 100 of FIGS. 1A-13C may not be described here but are understood to be present.

Waveguide 1700 includes a first end 1720 and a second, opposing end 1730, with first end flange 1722 and second end flange 1732 disposed at ends 1720 and 1730, respectively. Flanges 1722, 1732 are used to connect the waveguide 1700 to other RF system components (e.g., to another waveguide or directly to a system component through, for example, a complementary flange).

The waveguide 1700 includes waveguide body 1710 disposed between flanges 1722, 1732. The waveguide body is hollow and includes cavity 1718 that traverses the length of the waveguide body 1710. In some embodiment, flanges 1722, 1732 may comprise a single piece together with waveguide body 1710. In other embodiments flanges 1722, 1732 may be attached to the waveguide body 1710 after the waveguide body 1710 is manufactured as a single piece.

Waveguide body 1710 includes first and second linear sections 1712, 1714 and a curved section 1716 between the first and second linear sections 1712, 1714. The curved section 1716 includes (roughly) two spirals. In FIGS. 17C and 17D, an interior 1718 of the waveguide through which the RF waves are transmitted is shown.

In the embodiments shown herein in FIGS. 1A-13C and 17A-D the curved sections of the waveguide are roughly perpendicular to the linear sections of the waveguide. That is, the direction of transmission of the RF waves within the curved section is roughly perpendicular to the direction of the transmission of the RF waves within the linear sections However, any configuration of a curved section position between two linear sections may be used as long as the curved section provides flexibility and twistability and enables proper RF transmission while minimizing any issues such as PIM and insertion issues. Flexibility and twistability are increased directly with increases in the turns of the curved section.

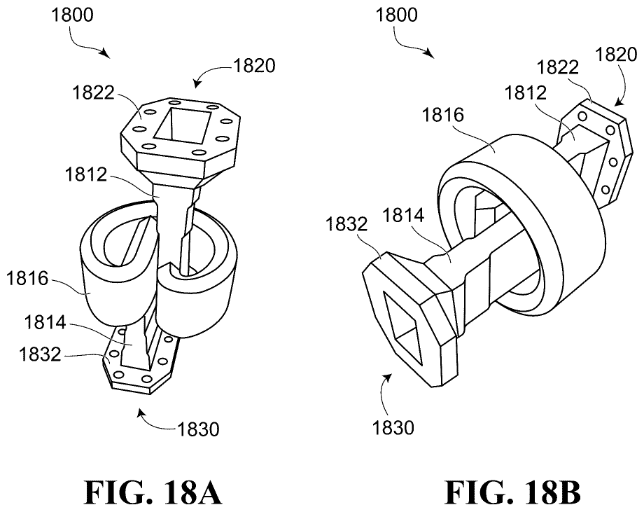

Referring now to FIGS. 18A and 18B, shown therein is a flexible twistable waveguide 1800, according to another embodiment. Waveguide 1800 is another embodiment of waveguide 100 in which first and second linear portions 1812, 1814 are straight, rather than substantially straight as in waveguide 100 of FIGS. 1A-13C. The linear portions 1812, 1814 are stepped down in size towards the flange. Such an embodiment may allow for a more compact area for connection. This can be advantageous in applications where there are constraints on space.

Waveguide 1800 includes a first end 1820 with a first flange 1822 and a second end 1830 with a second flange 1832.

Waveguide 1800 includes a waveguide body comprising a first linear section 1812, a second linear section 1814, and a curved section 1816. The first linear section 1812 is connected to first flange 1822 at a first end and a first end of the curved section 1816 at a second end. The second linear section 1814 is connected to a second end of the curved section 1816 at a first end and the second flange 1832 at a second end.

While the above description provides examples of one or more apparatus, methods, or systems, it will be appreciated that other apparatus, methods, or systems may be within the scope of the claims as interpreted by one skilled in the art.

1. A flexible twistable radiofrequency (“RF”) waveguide device for communicating RF waves between first and second RF system components, the waveguide device comprising:
a first flange for connecting the waveguide device to the first RF system component and a second flange for connecting the waveguide to the second RF system component;
a waveguide body formed as a single piece, the waveguide body for transmitting the RF waves through an interior cavity traversing a length of the waveguide body, the waveguide body comprising:
a first linear section, a curved section, and a second linear section, the first linear section extending from the first flange to a first end of the curved section and the second linear section extending from the second flange to a second end of the curved section;
wherein the waveguide body is elastically deformable, in up to six degrees of freedom, from an undeformed configuration to a deformed configuration, the deformed configuration being deformed in at least one of the six degrees of freedom.

2. The waveguide device of claim 1, wherein the waveguide body is composed of a an additively manufacturable material.

3. The waveguide device of claim 1 wherein the first flange and the second flange are formed together with the waveguide body as a single piece.

4. The waveguide device of claim 3 wherein the waveguide body, the first flange, and the second flange are composed of an additively manufacturable material.

5. The waveguide device of claim 1 wherein the waveguide body comprises a base material.

6. The waveguide device of claim 5 wherein a surface finish is applied to the base material.

7. The waveguide of claim 6 wherein the surface finish is a plating material.

8. The waveguide of claim 6, wherein the surface finish is a coating or paint material.

9. The waveguide device of claim 5 wherein the base material is a good conductor with a loss tangent greater than 100.

10. The waveguide device of claim 6 wherein the base material is plated with a plating material having a loss tangent (i) greater than the loss tangent of the base material and (ii) superior to 100.

11. The waveguide device of claim 6, wherein the base material is coated or painted with material having a loss tangent (i) greater than the loss tangent of the base material and (ii) superior to 100.

12. The waveguide device of claim 5 wherein the base material is chosen from a group consisting of: aluminum, copper, and brass.

13. The waveguide device of claim 7 wherein the plating material is chosen from a group consisting of silver, gold, and copper.

14. The waveguide device of claim 5 wherein the base material is a polymer, and wherein the polymer has a surface finish applied thereto composed of a high conductivity material with a loss tangent greater than 100.

15. A method of manufacturing a waveguide device comprising a first flange, a second flange, and a waveguide body including a first linear section, a curved section, and a second linear section, the method comprising:
additively manufacturing the waveguide device as a single piece wherein the first linear section extends from the first flange to a first end of the curved section and the second linear section extends from the second flange to a second end of the curved section, wherein the waveguide device comprises a base material characterized by a loss tangent greater than 100.

16. The method of claim 15, wherein the waveguide device comprises a base material having a loss tangent greater than 100.

17. The method of claim 15 further comprising applying a surface finish to the waveguide body, the surface finish composed of a material having a loss tangent greater than 100.

18. The method of claim 17, wherein applying the surface finish comprises plating the waveguide body with a metal having a loss tangent greater than 100.

19. The method of claim 17, wherein applying the surface finish comprises coating or painting the waveguide body with a high conductivity paint having a loss tangent greater than 100.

20. The product when made by the method of claim 15.
